(19) United States
(12) Patent Application Publication
(10) Pub. No.: US 2013/0180917 A1
(43) Pub. Date: Jul. 18, 2013

(54) HIGH FLUX MICROFILTRATION MEMBRANES WITH VIRUS AND METAL ION ADSORPTION CAPABILITY FOR LIQUID PURIFICATION

(71) Applicants: Benjamin Chu, Setauket, NY (US); Benjamin S. Hsiao, Setauket, NY (US); Hongyang Ma, East Setauket, NY (US); Ran Wang, Stony Brook, NY (US)

(72) Inventors: Benjamin Chu, Setauket, NY (US); Benjamin S. Hsiao, Setauket, NY (US); Hongyang Ma, East Setauket, NY (US); Ran Wang, Stony Brook, NY (US)

(73) Assignee: The Research Foundation of State University of New York, Albany, NY (US)

(21) Appl. No.: 13/817,224

(22) PCT Filed: Aug. 22, 2011
(86) PCT No.: PCT/US11/48555

§ 371 Date: Apr. 1, 2013

Related U.S. Application Data
(60) Provisional application No. 61/375,965, filed on Aug. 23, 2010.

(51) Int. Cl. B01D 61/18; B01D 37/00

(52) U.S. Cl. CPC B01D 61/18; B01D 37/00
USPC 210/634; 210/500.21

(57) ABSTRACT

Microfiltration membranes achieve high retention of bacteria and viruses by pore-size exclusion by the diameters of the fibers in the scaffold layer. The membranes have a high permeation flux as compared with conventional commercial micro filtration membranes under the same applied pressure. Ultra-fine nanofibers (fiber diameters from 3 nanometers to 50 nanometers and lengths from about 100 nanometers to about 5000 nanometers) are infused into, or deposited onto the surface of fibrous filtration media. Negatively charged ultra-fine nanofibers can include polysaccharide nanofibers prepared by a 2,2,6,6-tetramethylpiperidine-1-oxyl (TEMPO)INaBrINaCIO oxidation system in aqueous solution. Ultra-fine polysaccharide nanofibers having a large number of carboxylate groups are produced. (0.7-1.0 mmol/g cellulose) The carboxylate groups are negatively charged, and can interact with positively charged polymers/molecules by forming a complex. Such ultra-fine polysaccharide nanofibers have positive charges, that are effective for the removal of bacteria and viruses through adsorption.

### GOVERNMENT RIGHTS

This invention was made with Government Support under National Science Foundation (NSF DMR-1019370). The government has certain rights in the invention.

### BACKGROUND

Waters that are contaminated with some forms of bacteria, viruses, and toxic heavy metal ions are responsible for close to 1.8 million deaths each year. Most of these deaths are in developing countries. Heavy metal ions include, for example, lead, arsenic, mercury, antimony and chromium (VI). Radioactive species such as U²³⁸, Cs¹³⁷, Pu²³⁹, and I¹³¹, discharged into the environment, particularly by nuclear power plant catastrophes, can also be a unique concern. Water purification that successfully eliminates bacteria, viruses, toxic heavy metal ions, and radioactive metal ions from water sources can be an expensive process. Therefore, it is increasingly urgent to find effective, low cost technologies to eliminate this type of contamination.

Microfiltration (MF) is a technology utilized for water purification which separates dissolved macromolecules and/or particles on the basis of size by passing a solution/suspension through a fine pore-sized filter. The microfilter is generally a tough, thin, selectively permeable membrane that retains most macromolecules and/or particles above a certain size, including most bacteria. Thus, MF provides a retained fraction (retentate) that is rich in large molecules and/or particles and a filtrate that contains very few, if any of these macromolecules and/or particles.

Microfiltration, however, cannot be used to filter viruses out of a feed solution since viruses are too small to be excluded by the pores of a microfilter. Viruses can be removed from feed solutions by ultrafiltration, nanofiltration or reverse osmosis. These types of filtration require costly materials and operations. Water that will be passed through an ultrafiltration, nanofiltration, or reverse osmosis membrane is normally pretreated to remove articles that could be harmful to the membrane. Oftentimes, the pretreatment includes passing the feed solution through a microfilter. Because of the necessary pretreatment, ultrafiltration, nanofiltration and reverse osmosis plants are larger and more costly than microfiltration plants.

In addition to using relative large pore size microfiltration, removal of toxic metals from aqueous solution is usually performed by means of other methods, such as ion exchange, neutralization, reverse osmosis, precipitation, solvent extraction, and/or adsorption. However, most of these processes have disadvantages, including high operation costs arising from the consumption of chemicals or electricity, and technical problems which may arise due to long time period for extraction, complex treatment procedures, and the production of toxic sludge that is difficult to dispose. Among these processes, adsorption has been shown to be an economically possible alternative, due to flexibility in design and operation, and its ability to produce high-quality treated effluent. Moreover, because adsorption is sometimes reversible, adsorbents can be regenerated by suitable desorption processes.

Improvements in technology that can effectively remove bacteria, viruses, toxic heavy metal ions, and radioactive ions, and can retain the benefits of microfiltration over other types of membrane filtration, remain desirable.

### SUMMARY

The present disclosure provides microfiltration membranes that successfully achieve high retention of bacteria and viruses as well as toxic and/or radioactive ions. The membranes have a high permeation flux as compared with conventional commercial microfiltration membranes under the same applied pressure. Additionally, the membranes have a low pressure drop as compared with conventional commercial micro-filtration membranes under the same flow rate.

In embodiments, the membranes have a composite fibrous structure containing an electrospun nanofibrous scaffold (fiber diameters from 50 to 1000 nanometers) on a mechanically strong microfibrous substrate (fiber diameters from 1 to 100 μm). In some embodiments, multiple membranes may be combined in any suitable configuration. For example, two membranes may be used in series, either with the two electrospun nanofibrous scaffolds facing inward and the two substrate layers facing outward, or with both membranes oriented in the same direction, with either the electrospun nanofibrous scaffolds upstream of the substrate layers, or with the substrate layers upstream of the two nanofibrous scaffold layers. In some embodiments, the layers of the composite fibrous structure are combined with ultra-fine nanofibers, in some cases polysaccharide nanofibers (having fiber diameters from 3 to 50 nanometers and lengths from about 100 to about 5000 nanometers).

The composite structure effectively removes bacteria by pore-size exclusion, which is defined by the diameters of the fibers in the scaffold layer. Viruses and toxic/radioactive metal ions are smaller than bacteria and cannot be removed solely by pore size exclusion with a micro-filtration membrane. However, this modification of the membrane, wherein the membrane is combined with ultra-fine nanofibers, successfully effects virus and metal ion retention.

In embodiments, the ultra-fine nanofibers (fiber diameters from 3 nanometers to 50 nanometers and lengths from about 100 nanometers to about 5000 nanometers) are infused into, or deposited onto the surface of, fibrous filtration media that may be produced by methods other than electrospinning, or infused into, or deposited onto the surface of, non-fibrous microfiltration membrane that may be available from a number of commercial sources.

The disclosure also describes a further surface modification of the ultra-fine nanofibers, including the introduction of one or more positively charged (for removal of negatively charged viruses or ions) or negatively charged (for removal of positively charged metal ions) water-soluble polymers or molecules. The ultra-fine nanofibers, before the introduction of the positively charged or negatively charged water-soluble polymers or molecules, have a low degree of natural negative charge due to the oxidation process in fabricating the ultra-fine nanofibers. In embodiments, the negatively charged ultra-fine nanofibers can include polysaccharide nanofibers prepared by a 2,2,6,6-tetramethylpiperidine-1-oxyl (TEMPO)/NaBr/NaClO oxidation system in aqueous solution. In embodiments, the C₆-hydroxyl group is oxidized to a certain degree with this oxidation system. After oxidation, both carboxylate and aldehyde groups may be produced, in addition to the original hydroxyl groups. After mild mechanical treatment (e.g., stirring or mixing with a homogenizer at a speed of 5000 rpm), ultra-fine polysaccharide nanofibers having a large number of carboxylate groups are produced. (0.7˜1.0 mmol/g cellulose) The carboxylate groups are negatively charged, and can interact with positively charged polymers/molecules by forming a complex. The modification process results in ultra-fine polysaccharide nanofibers with positive charges, that are effective for the removal of viruses through adsorption (especially when the feed solution containing viruses is at a high pH value). Similarly, the surface of polysaccharide nanofibers itself is negatively charged or can be further attached with negatively charged polymers/molecules, resulting in having negatively charged properties. This modification should be effective for the removal of toxic metals (positively charged) through adsorption. With the above pathways, the membrane can be designed for adsorption of different viruses as well as metal ions.

This disclosure also describes a method for the production of membranes of the present disclosure. The fabrication of the membranes is an environmentally friendly process since water is the primary solvent involved in the cellulose infusion procedure.

### BRIEF DESCRIPTION OF THE FIGURES

Various embodiments of the present disclosure will be described herein with reference to the following figures, wherein:

FIG. 1 is a graph of a water bubble point vs. scaffold layer thickness for different types of substrate layers: 8 wt % PAN/NOVATEXX 2413, and 8 wt % PAN/AWA;

FIG. 2 is a graph of water flow rate vs. pressure for a membrane including 8 wt % PAN/AWA with different thicknesses of the scaffold layer;

FIG. 3 is a graph of thicknesses of the scaffold layer for a membrane including 8 wt % PAN/AWA vs. soaking time for IPA/water solutions at different concentrations of IPA;

FIG. 4 is a graph of water bubble points for a membrane including 8 wt % PAN/AWA vs. soaking time for IPA/water solutions at different IPA concentrations;

FIG. 5 is a graph of pressure drop of 8 wt % PAN/AWA membranes vs. soaking time for IPA/water solutions at different IPA concentrations;

FIG. 6 is a depiction of a two layered fibrous structure with a top nanofibrous layer infused with ultra-fine nanofibers;

FIG. 7 is a transmission electron microscope (TEM) image of cellulose ultra-fine nanofibers (sometimes referred to, in embodiments, as nanowhiskers) fabricated by the TEMPO/NaBr/NaClO oxidation method (the inset shows the electron diffraction pattern);

FIG. 8 is scanning electron microscope (SEM) images of cross-sectional views of PAN electrospun nanoscaffolds (a) and cellulose nanowhisker modified PAN electrospun nanoscaffolds (b);

FIG. 9 is a graph showing the pore size distribution of PAN electrospun scaffolds and the cellulose nanowhisker microfiltration membrane;

FIG. 10 is a graph showing the mechanical properties of PAN electrospun scaffolds and the cellulose nanowhisker nanocomposite membrane;

FIG. 11 is a graph showing the adsorption capacities of the cellulose nanowhisker membrane and a commercially available membrane (GS0.22) against time; and

FIG. 12 is a graph showing the Langmuir adsorption isotherms of the cellulose nanowhisker membrane and the commercially available membrane (GS0.22).

FIGS. 13A-C show the morphology of ultra-fine cellulose nanofibers as follows: 13A, after adsorption of UO₂²⁺ (A, inset); 13B, an electron diffraction pattern of cellulose nanofibers before adsorption of UO₂²⁺; and 13C, after adsorption of UO₂²⁺.

FIG. 14 is a graph showing UO₂²⁺ adsorption capacity on ultra-fine cellulose nanofibers.

### DETAILED DESCRIPTION

The present disclosure provides high-flux, low pressure drop filtration membranes for the removal of bacteria and viruses, as well as metal ions, from any liquid. In embodiments, the membranes may be utilized to remove these items from water supplies. In other embodiments, the filters may be used to remove these items from food products, for example wine and beer, from pharmaceutical or biopharmecutical product streams, and the like. The membranes may be used to produce low-cost and high-performance microfiltration (MF) filters.

The bacteria B diminuta, which has an average size of about 0.31 μm (OD) by 0.88 μm (length), and E. coli, which has an average size of about 0.50 μm (OD) by 2.0 μm (length), may be effectively removed by filters with a maximum pore size of about 0.60 μm and a mean pore size of about 0.20 μm. Some microfilters have pores within this range. However, viruses, such as MS2 bacteriophage (MS2), with an average size of about 27 nm (diameter) by 32 nm (length), cannot be removed by conventional microfiltration media.

As used herein, a microfiltration filter includes a filter having pore sizes comparable or smaller than the particles the filter is designed to exclude, with an average pore or channel sized from about 0.1 microns to about 10 microns, in embodiments from about 0.15 microns to about 0.3 microns.

In embodiments, the high flux and low pressure drop microfiltration membrane may be prepared with electrospun nanofibrous scaffolds and ultra-fine nanofibers. These ultra-fine nanofibers may be referred to, in embodiments, as nanowhiskers. As used herein, the ultra-fine nanofibers include any cross-linkable nanofibers or nanotubes capable of being combined with a scaffold so that they are not removed during a filtration. In embodiments, suitable nanofibers include polyolefins, polysulfones, polyethersulfones, fluoropolymers, polyvinylidene fluorides, polyesters, polyamides, polycarbonates, polystyrenes, polyacrylonitriles, poly(meth)acrylates, polyvinylacetates, polyvinyl alcohols, polysaccharides, cellulose, chitosan, chitin, hyaluronic acid, proteins, polyalkylene oxides, polyurethanes, polyureas, polyvinyl chlorides, polyimines, polyvinylpyrrolidones, polyacrylic acids, polymethacrylic acids, polysiloxanes, poly(ester-co-glycol)polymers, poly(ether-co-amide)polymers, cross-linked forms thereof, derivatives thereof, copolymers thereof, and combinations thereof. In embodiments, suitable ultra-fine nanofibers may include polysaccharides, in embodiments cellulose.

The efficiency of these filters meet the critical requirements where 6 log reduction value (LRV) for bacteria and 4 LRV for viruses can be achieved, while the flux rate is over 5 times higher than that of commercially available MF counterparts. The composite MF filter can be readily scaled up for mass production.

The membranes of the present disclosure, sometimes also referred to herein as filters, include a composite structure with one or more layers. One layer includes a non-woven nanofibrous scaffold. The second layer is a microfibrous substrate that provides mechanical support to the filter. The layered structure allows for effective bacteria removal by pore size exclusion. In some embodiments, the scaffold layer includes electrospun nanofibers. In embodiments, ultra-fine nanofibers are infused into, or deposited onto, either or both of the nanofibrous scaffold and the microfibrous substrate layers. The ultra-fine nanofibers, in embodiments, polysaccharides, that possess a natural positive charge can adsorb viruses (negatively charged) [or metal ions (positively charged, or negatively charged oxides)], thereby allowing the filter to effectively remove viruses from a feed solution. The filters of the present disclosure thus allow both bacteria and viruses to be removed from an aqueous flow in one microfiltration step.

In some embodiments the fibrous structure possessing ultra-fine nanofibers, can be further modified by the addition of one or more positively charged water-soluble polymers/molecules to enhance the virus adsorption capability, especially when the feed flow is at a high pH (i.e. 6.5-8.5). The surface of ultra-fine nanofibers can also be attached with negatively charged polymers/molecules to enhance the metal ion (positively charged) adsorption capability,

The present disclosure provides a method for fabricating these high-flux and low pressure drop microfiltration filters for fluid filtration. Any fluid may be filtered with the filters of the present disclosure. In embodiments, the fluid may be drinking water.

The present disclosure also provides a method for fabricating effective absorbent materials for the removal of viruses and toxic metals, in the form of metal ions.

In embodiments, the present disclosure utilizes electro-spun/electro-blown nanofibrous scaffolds as the filter membrane. The scaffolds are supported by a mechanically strong microfibrous substrate material. Ultra-fine nanofibers, in embodiments, cellulose nanofibers, are infused into, or deposited onto, the fibers of the scaffold and/or substrate layers.

In some embodiments, two filters as described above are used in combination. The filters may be combined in any suitable orientation. In embodiments, the filters may be arranged so that the two scaffold layers face each other and away from the feed solution. Alternatively, the two filters may be arranged so that each scaffold layer is upstream from its substrate layer.

The filters of the present disclosure may include any substrate currently in use with microfiltration membranes, including, but not limited to, hydrophilic polymers, hydrophobic polymers, hydrophilic/hydrophobic copolymers, polyelectrolytes and ion-containing polymers. Specific examples of polymers which may be utilized include, but are not limited to, polyolefins including polyethylene and polypropylene, polyesters including polyethylene terephthalate, polytrimethylene terephthalate and polybutylene terephthalate, polyamides including nylon 6, nylon 66, and nylon 12, polyurethanes, fluorinated polymers, polyetherketones, polystyrene, sulfonated polyetherketones, sulfonated polystyrene and derivatives thereof, cellulose and derivatives thereof, and copolymers thereof. In some embodiments, commercially available non-woven substrates made of polyethylene terephthalate (PET), propylene, including isotactic polypropylene (iPP), polyethylene (PE), glass, cellulose and cellulose-based polymers, and fluorinated polymers may be used as the substrate.

In some embodiments, suitable substrate may include hydrophobic/hydrophilic copolymers. Such copolymers include, but are not limited to, polyurethane copolymers, polyurea copolymers, polyether-b-polyamide, PEG modified fluorinated copolymers, ethylene-propylene copolymers, cellulose based copolymers, ethylene based copolymers, and propylene based copolymers. These copolymers, which possess excellent mechanical strength and durability, may be useful in embodiments where such characteristics are desired for the filter.

Other suitable substrates may be porous membranes, including those fabricated by a phase inversion method. Phase inversion methods are within the purview of those skilled in the art and generally include: (1) casting a solution or mixture possessing high molecular weight polymer(s), solvent(s), and nonsolvent(s) into thin films, tubes, or hollow fibers; and (2) precipitating the polymer. The polymer may be precipitated, in embodiments, by: evaporating the solvent and nonsolvent (dry process); exposing the material to a nonsolvent vapor (e.g. water vapor), which absorbs on the exposed surface (vapor phase-induced precipitation process); quenching in a nonsolvent liquid, generally water (wet process); or thermally quenching a hot film so that the solubility of the polymer is greatly reduced (thermal process).

Suitable porous substrates, including those prepared by phase inversion process, are within the purview of those skilled in the art and include, for example, substrates produced from polymers such as polysulfones (e.g. polyethersulfone), cellulose acetates, fluoropolymer (e.g. polyvinylidene fluoride (PVDF) and polyoxyethylene methacrylate (POEM) grafted PVDF), polyamides (e.g. poly-ether-b-polyamide), and polyimides. Such substrates may have a pore size of from about 5 nm to about 500 nm, in embodiments, from about 20 nm to about 100 nm.

In some embodiments, non-woven poly(ethylene terephthalate) (PET) micro filters (commercially available as AWA16-1 from SANKO LIMITED, 1316-1 Kawamuko cho, Tsuzuki-ku, Yokohama, 224-0044 Japan, with an average fiber diameter of about 20 μm) can be used as the substrate. In other embodiments, non-woven PET micro filters (commercially available as NOVATEXX 2413 from Freudenberg Filtration Technologies KG, D-69465 Weinheim, Germany), with an average fiber diameter of 20 μm, can be used as the substrate.

As noted above, in embodiments the above substrate may be used with a nanofibrous scaffold, sometimes referred to herein as a nanofibrous membrane. These scaffolds may be made of suitable polymers within the purview of one skilled in the art, including, but not limited to, polyolefins including polyethylene and polypropylene, polysulfones such as polyethersulfone, fluoropolymers such as polyvinylidene fluoride, polyesters including polyethylene terephthalate, polytrimethylene terephthalate, and polybutylene terephthalate, polyamides including nylon 6, nylon 66, and nylon 12, polycarbonates, polystyrenes, polyacrylonitrile, polyacrylates such as polymethyl methacrylate, polyacetates such as polyvinyl acetate, polyalcohols such as polyvinyl alcohol, polysaccharides (such as chitosan, cellulose, collagen, or gelatin), proteins such as chitin, hyaluronic acid, polyalkylene oxides such as polyethylene oxide and polyethylene glycol, polyurethanes, polyureas, polyvinyl chloride, polyimines such as polyethylene imine, polyvinylpyrrolidone, polyacrylic acids, polymethacrylic acids, polysiloxanes such as polydimethylsiloxane, poly(ester-co-glycol) copolymers, poly(ether-co-amide) copolymers, crosslinked forms thereof, derivatives thereof and copolymers thereof. In some embodiments, poly(acrylonitrile) (PAN), polyethersulfone (PES), polyvinylidenefluoride (PVDF), crosslinked water soluble polymers, e.g., polyvinylalcohol (PVA), modified cellulose and modified chitosan, their chemical derivatives and copolymers may be utilized. Combinations of the foregoing may also be used to form suitable scaffolds.

In some embodiments, it may be desirable to crosslink fluid-soluble polymers. For example, water-soluble polymers, such as polyvinyl alcohol, polysaccharides (including chitosan and hyaluronan), polyalkylene oxides (including polyethylene oxide), gelatin and their derivatives to render these polymers suitable for use as a hydrophilic nanofibrous scaffold. Crosslinking may be conducted using methods within the purview of those skilled in the art, including the use of crosslinking agents. Suitable crosslinking agents include, but are not limited to, C₂-C₈ dialdehyde, C₂-C₈ diepoxy, C₂-C₈ monoaldehydes having an acid functionality, and C₂-C₉ polycarboxylic acids. These compounds are capable of reacting with at least two hydroxyl groups of a water-soluble polymer. Other suitable crosslinking methods include conventional thermal-, radiation- and photo-crosslinking reactions within the purview of those skilled in the art. Two important criteria for the selection of a crosslinking agent or method are as follows: (1) the crosslinking agent or method should not dissolve the nanofibrous scaffold layer, and (2) the crosslinking agent or method should not induce large dimensional change, e.g., hydrophilic electrospun nanofibrous scaffold layers may display very large shrinkage in hydrophobic solvents such as hydrocarbons because of their hydrophilic nature.

Specific examples of crosslinking agents which may be utilized include, but are not limited to, glutaraldehyde, 1,4-butanediol diglycidyl ether, glyoxal, formaldehyde, glyoxylic acid, oxydisuccinic acid and citric acid. In some embodiments, it may be useful to treat polyvinyl alcohol with a crosslinking agent such as glutaraldehyde.

The amount of crosslinking agent added to the water-soluble polymer such as polyvinyl alcohol may vary, from about 0.1 to about 10 percent by weight of the combined crosslinking agent and polymer, in some embodiments from about 0.5 to about 5 percent by weight of the combined crosslinking agent and polymer.

In embodiments, the nanofibrous scaffold supports which may be utilized in forming the membranes of the present disclosure: (1) may be utilized by themselves to form membranes of the present disclosure; (2) may be applied to a substrate as described above to form a filter of the present disclosure; or (3) may be combined with ultra-fine nanofibers, in embodiments polysaccharide nanofibers, to form a filter of the present disclosure.

In some embodiments, the fiber diameter of the fibers making up the composite fibrous scaffolds can be from about 1 nm to about 20,000 nm. In embodiments, the fiber diameters of ultra-fine nanofibers, in embodiments polysaccharide nanofibers, (sometimes referred to as nanowhiskers) may be from about 3 nm to about 50 nm, in embodiments from about 5 nm to about 30 nm, in embodiments from about 10 nm to about 25 nm, the fiber diameters of electrospun nanofibrous scaffolds may be from about 50 nm to about 500 nm, in embodiments from about 100 nm to about 400 nm, and the fiber diameters of non-woven substrate may be from about 1 μm to about 100 μm, in embodiments from about 5 μm to about 25 μm.

The fiber length of ultra-fine nanofibers, in embodiments polysaccharide nanofibers, may be from about 100 nm to about 5000 nm, in embodiments from about 500 nm to about 2500 nm, in embodiments from about 750 nm to about 1500 nm.

The thickness of the nanofibrous scaffold may vary from about 1 μm to about 500 μm, in embodiments from about 10 μm to about 300 μm, in embodiments from about 30 μm to about 150 μm in thickness. In some embodiments, the thickness of the scaffold is from about 40 μm to about 50 μm.

The nanofibrous scaffold possesses pores or voids which assist in the functioning of the membranes of the present disclosure. The diameter of these voids may be from about 10 nm to about 200 μm, in embodiments from about 50 nm to about 30 μm, in embodiments from about 100 nm to about 10 μm. In some embodiments, the pore size may be from about 0.2 μm to about 0.6 μm.

In embodiments, the scaffold layer of the membrane, such as polyacrylonitrile (PAN) or polyethersulfone (PES), may be electrospun on a substrate, such as a non-woven polyethylene terephthalate (PET) micro-filter (AWA16-1 from SANKO LIMITED, 1316-1 Kawamuko cho, Tsuzuki-ku, Yokohama, 224-0044 Japan) utilizing methods within the purview of those skilled in the art.

In forming the nanofibrous scaffold of the present disclosure, the polymer is often first placed in a solvent, such as N,N-dimethyl formamide (DMF), tetrahydrofuran (THF), methylene chloride, dioxane, ethanol, propanol, butanol, chloroform, water, or mixtures of these solvents, so that the polymer is present at an amount from about 1 to about 40 wt %, in embodiments from about 3 to about 25 wt %, in embodiments from about 5 to about 15 wt % of polymer solution.

In some embodiments, it may be desirable to add a surfactant or another solvent-miscible liquid to the polymer solution utilized to form the nanofibrous scaffold to lower the surface tension of the solution, which may help stabilize the polymer solution during electro-spinning, electro-blowing, and the like. Suitable surfactants include, for example, octylphenoxypolyethoxy ethanol (commercially available as TRITON X-100), sorbitan monolaurate, sorbitan sesquioleate, glycerol monostearate, polyoxyethylene, polyoxyethylene cetyl ether, dimethyl alkyl amines and methyl dialkyl amines, and the like. Where utilized, the surfactant may be present in an amount from about 0.001 to about 10 percent by weight of the polymer solution, in embodiments from about 0.05 to about 5 percent by weight of the polymer solution, in embodiments from about 0.1 to about 2 percent by weight of the polymer solution. The solvent miscible fluid forms a solvent mixture with the solvent that can dissolve the polymer but changes the surface tension of the polymer solution and the evaporation rate of the solvent mixture.

In embodiments, the nanofibrous scaffold may be fabricated using electro-spinning, electro-blowing, blowing-assisted electro-spinning, and/or solution blowing technologies. Blowing-assisted electro-spinning and electro-blowing both use electric force and gas-blowing shear forces. In blowing-assisted electro-spinning processes, the electric force is the dominating factor, while the gas-blowing feature can assist in shearing the fluid jet stream and in controlled evaporation of the solvent (lower throughput, smaller diameter). In contrast, in electro-blowing processes the gas-blowing force is the dominating factor to achieve the desired spin-draw ratio, while the electric force may enable further elongation of fiber (higher throughput, larger diameter). Electro-spinning processes use only electric force, but without the assistance of gas flow. To the contrary, solution blowing processes use only gas flow, without the use of electric force.

The applied electric field potentials utilized in electrospinning can vary from about 10 to about 40 kV, in embodiments from about 15 to about 30 kV, with a distance between the spinneret and the collector of from about 5 to about 20 cm, in embodiments from about 8 to about 12 cm, and a solution flow rate of from about 10 to about 40 μl/minute, in embodiments from about 20 to about 30 μl/minute. In one embodiment the electrospinning process can use an applied electric field strength of about 2 kV/cm and a solution flow rate of about 25 μl/minute.

Methods for forming fibers by electro-blowing are within the purview of those skilled in the art and include, for example, the methods disclosed in WO 2007/001405 and U.S. Patent Publication No. 2005/0073075, the entire disclosures of each of which are incorporated by reference herein. Briefly, in an electro-blowing process, an electrostatic field is combined with a gaseous flow field. Like melt blowing (no charge required), where the liquid droplet is pulled out by the gaseous flow, with electro-blowing the combined forces are strong enough to overcome the surface tension of the charged liquid droplet. This permits the use of electrostatic fields and gas flow rates that are significantly reduced compared to either method alone.

Both the gaseous flow stream and the electrostatic field are designed to draw the fluid jet stream very fast to the ground. The spin-draw ratio depends on many variables, such as the charge density of the fluid, the fluid viscosity, the gaseous flow rate and the electrostatic potential. In some embodiments, these variables can be altered in mid-stream during processing. For example, injection of electrostatic charges can be used to increase the charge density of the fluid or even convert a neutral fluid to a charged fluid. The temperature of the gaseous flow can also change the viscosity of the fluid. The draw forces increase with increasing gaseous flow rate and applied electrostatic potential.

The intimate contact between the gas and the charged fluid jet stream provides more effective heat transfer than that of an electro-spinning process where the jet stream merely passes through the air surrounding the jet stream. Thus, the gas temperature, the gas flow rate, and the gaseous streaming profile can affect and control the evaporation rate of the solvent if the fluid is a solution. The gas temperature can vary from liquid nitrogen temperature to super-heated gas at many hundreds of degrees; a suitable temperature depends on the desired evaporation rate for the solvent and consequently on the solvent boiling temperature. The streaming profiles are aimed at stabilizing the jet streams and should be similar to those used in melt blowing.

In electro-blowing embodiments, the feeding rate of the polymer solution per spinneret for forming the nanofibrous scaffold may be from about 5 to about 2500 μL/minute, in embodiments from about 20 to about 300 μL/minute, in embodiments from about 35 to about 150 μL/minute. The air blow temperature may be from about 0° C. to about 200° C., in embodiments from about 20° C. to about 120° C., in embodiments from about 25° C. to about 90° C. The air blow rate per spinneret may vary from about 0 standard cubic feet per hour (SCFH) to about 300 SCFH, in embodiments from about 5 SCFH to about 250 SCFH, in embodiments from about 20 SCFH to about 150 SCFH. The electric potential can be from about 1 kV to about 55 kV, in embodiments from about 15 kV to about 50 kV, in embodiments from about 30 kV to about 40 kV, with a conventional spinneret to collector distance of about 10 cm.

Where the nanofibrous scaffold is formed by blow-assisted electrospinning, the feeding rate of the polymer solution per spinneret for forming the nanofibrous scaffold may be from about 5 to about 150 μL/minute, in embodiments from about 10 to about 80 μL/minute, in embodiments from about 20 to about 50 μL/minute. The air blow temperature may be from about 0° C. to about 200° C., in embodiments from about 20° C. to about 120° C., in embodiments from about 25° C. to about 90° C. The air blow rate per spinneret may vary from about 0 standard cubic feet per hour (SCFH) to about 300 SCFH, in embodiments from about 5 SCFH to about 250 SCFH, in embodiments from about 20 SCFH to about 150 SCFH. The electric potential can be from about 1 kV to about 55 kV, in embodiments from about 15 kV to about 50 kV, in embodiments from about 20 kV to about 40 kV, with a conventional spinneret to collector distance of about 10 cm.

In other embodiments, nanofibrous scaffolds in accordance with the present disclosure may be formed by solution blowing, which is similar to melt blowing except a polymer solution instead of a polymer melt is used to fabricate the scaffolds. Such techniques are within the purview of those skilled in the art and include the formation of a polymeric material and blowing agent in a single phase, in embodiments a liquid, which is then sprayed utilizing conventional equipment similar to that utilized in electro-blowing, except that an electrical field is not utilized in spraying the liquid. Parameters useful for solution blowing include, for example, the use of very high shear forces obtained by using gas flow at speeds from about one hundredth of the speed of sound to near the speed of sound in air, i.e., about 600 miles per hour.

An asymmetric nanofibrous scaffold containing different fiber diameters and porosity can be used in some embodiments. In embodiments, the nanofibrous scaffold possesses two or more different layers. The fibers making up each layer of the nanofibrous scaffold may, in some embodiments, have a different diameter compared to the fibers making up other layers of the nanofibrous scaffold. For example, fibers making up one layer of the nanofibrous scaffold may have diameters from about 200 nm to about 10,000 nm, in embodiments from about 400 nm to about 2,000 nm, in embodiments from about 500 nm to about 1,000 nm, while fibers making up another layer of the nanofibrous scaffold may have diameters from about 5 nm to about 500 nm, in embodiments from about 15 nm to about 300 nm, in embodiments from about 30 nm to about 200 nm. The diameter of fibers may thus exhibit a gradient in size between layers. In such an embodiment, smaller diameter fibers of the bottom surface of the nanofibrous scaffold may be immediately adjacent to the substrate, and larger diameter fibers of the top surface of the nanofibrous scaffold may be on the opposite face of the scaffold, or vice-versa. Multiple layers, in embodiments more than the two layers described above, may be similarly combined to form a scaffold having multiple layers with different diameter fibers. Larger fiber diameters may be on top of smaller fiber diameters; smaller fiber diameters may be on top of large fiber diameters; and any combinations thereof.

The nano-fibrous scaffold, the substrate, or optionally a combination of both the nano-fibrous scaffold and the substrate may form the basis for the high-flux and low-pressure microfiltration membranes of the present disclosure.

Where both a nanofibrous scaffold and non-woven micro-filter substrate are present in a membrane of the present disclosure, de-lamination can occur between the substrate and scaffold. Thus, in some embodiments, in order to enhance the adhesion between the substrate, such as a PET substrate, and the scaffold, such as an electrospun PAN, it may be useful to first coat one side of PET substrate with a solution including water insoluble chitosan, crosslinked PVA, crosslinked polyethylene oxide (PEO), their derivatives and copolymers to enhance adherence of the scaffold layer to the substrate. As noted above, water soluble materials such as PVA and PEO may be crosslinked with known crosslinking agents, including, but not limited to, glutaraldehyde, glyoxal, formaldehyde, glyoxylic acid, oxydisuccinic acid and citric acid.

In one embodiment, a 0.7 wt % neutralized chitosan (Mv=200,000 g/mol) aqueous solution may be utilized as an adhesive layer between the substrate and scaffold. In such a case, the chitosan or other adhesive may be applied to the substrate utilizing methods within the purview of one skilled in the art including, but not limited to, spraying, dipping, solution casting and the like. Before complete drying of the chitosan coating on the substrate, the scaffold nanofibers of PAN or PVA (from a 10 wt % in DMF) may be electrospun onto the chitosan coated layer at about 2 kV over a distance between the spinneret and the collector of about 10 cm, with a solution flow rate of 25 μl/minute. The fiber diameter of electrospun nanofiber scaffold may range from about 150 nm to about 200 nm.

In other embodiments, the nanofibrous scaffold may be subjected to a plasma treatment to enhance its adherence to a substrate and/or coating layer in forming a membrane of the present disclosure. Plasma treatment methods are within the purview of those skilled in the art, including, for example, atmospheric pressure plasma treatment on non-woven fabrics. This method has been demonstrated to be an effective means to improve the wettability as well as the affinity of the fiber surface for dyeing, chemical grafting and substrate adhesion. Plasma activation can produce functional groups and/or free radicals on the fiber surface, which can react with other molecules.

In one embodiment, a plasma treatment may be conducted as follows. The surface of a substrate can be functionalized by subjecting it to an atmospheric-pressure plasma treatment using a surface dielectric barrier discharge in nitrogen gas, ambient air, or other gases such as helium, ammonia, oxygen and/or fluorine. At the same time, the surface of a nanofibrous scaffold may be treated with the same plasma. The resulting plasma-activated substrate may be bound to another substrate, another plasma-activated substrate, a porous scaffold layer, a plasma-activated porous scaffold layer, or a plasma-activated nanofibrous scaffold using a catalyst-free solution of water in combination with acrylic acid, polysaccharides such as chitosan, cellulose, collagen and gelatin, epoxy, or combinations thereof. The plasma treatment can significantly improve the adhesion of a substrate with other layers of the membrane, including any nanofibrous scaffold of the present disclosure or other layer utilized in the formation of membranes of the present disclosure.

In embodiments, the filter of the present disclosure is modified by infusing or depositing ultra-fine nanofibers, in embodiments polysaccharide nanofibers, into or onto either one or both of the scaffold and substrate layers. In embodiments, the fine fibers are nanofibers. As noted above, the ultra-fine nanofibers may be referred to, in embodiments, as nanowhiskers. The nanofibers can be used to adsorb viruses and toxic metal ions from water or other liquids and/or solutions by taking advantage of electrostatic and/or hydrophobic interactions.

In embodiments, ultra-fine polysaccharide nanofibers can include cellulose, chitin, collagen, gelatin, chitosan, cellulose nanocrystals, combinations thereof, and the like.

In some embodiments, the ultra-fine nanofibers include cellulose nanofibers (CN) having a diameter of from about 3 nm to about 50 nm, in embodiments from about 4 nm to about 20 nm, in embodiments about 5 nm, and a length of from about 50 nm to about 10000 nm, in embodiments from about 100 nm to about 2000 nm, in embodiments about 200 nm.

Cellulose nanofibers can be prepared according to the procedure described in WO2010/042647, the disclosure of which is incorporated by reference herein in its entirety. For example, in embodiments a cellulose nanofiber aqueous solution at a concentration from about 0.001 wt % to about 0.40 wt %, in embodiments from about 0.05 wt % to about 0.1 wt %, may be applied to a two layered filter of the present disclosure. The cellulose nanofiber solution is infused into the filter by the application of from about 0.1 pounds per square inch (psi) to about 20 psi of pressure, in embodiments from about 1 psi to about 10 psi of pressure, in embodiments about 2 psi of pressure from a gas tank. The infusion procedure can also be accomplished by applying vacuum through the opposite side of the filter of the present disclosure in direct contact with a cellulose nanofiber aqueous solution. The filter is then dried in an oven at a suitable temperature of from about 25° C. to about 200° C., in embodiments from about 50° C. to about 150° C., in embodiments about 100° C., for a suitable period of time, in embodiments from about 5 minutes to about 40 minutes, in embodiments from about 10 minutes to about 30 minutes, in embodiments about 20 minutes.

Suitable oxidation procedures to generate ultra-fine nanofibers, in embodiments, polysaccharide nanofibers, include the following. In embodiments, a TEMPO/NaBr/NaClO aqueous oxidation system may be used to generate carboxylate groups which are negatively charged on the surface of polysaccharide. For example, C₆-hydroxyl group can be oxidized into carboxylate groups. The negatively charged polysaccharide nanofibers can be produced by mechanical treatment and dispersed in water with certain concentrations. This suspension is the infused solution used.

In some embodiments, the two layered membrane can be further modified by dip-coating the filter into an aqueous solution of a positively charged polymer/molecule. This will cause the cellulose nanofibers to have a positive charge, which will aid in virus adsorption. The particular type and amount of polymer can be chosen based on the pH of the feed solution. At pH values below the isoelectric point of the virus, the virus could coagulate together, which would increase the effective size of the virus to be filtered to a few microns. The virus would adsorb onto the membrane and block the pores. Therefore, for practical applications, high pH values (around neutral or higher), may be desirable.

In embodiments, introduction of positive charges on cellulose nanofibers may be carried out by grafting chelating groups, including amino groups such as polyethylenimine and diamine, and/or sulfhydryl groups such as cystine and thiazolidine, onto the nanofibers by a reaction catalyzed by 1-ethyl-3-(3-dimethylaminopropyl)carbodiimide hydrochloride (EDC) and N-hydroxysuccinimide (NHS). Amino groups, in embodiments, may be primary, secondary, and/or tertiary amino groups. The amino group may be selected to optimize its activity depending upon factors such as pH.

As an example, the isoelectric point of MS2 is 3.9, for a virus solution at high pH values (between about 6.5 and 8.5). A filter membrane with a positively charged surface would aid in MS2 adsorption since MS2 is negatively charged at these pH values.

In other embodiments, positively charged materials which may be added to the substrate layer, the scaffold layer, or both, include positively polymers or other molecules, including, for example, polyethylenimine (PEI), polyvinylamine hydrochloride (PVAH), polyvinyl trimethylammonium chloride/bromide, poly(vinyl tetraethylphosphonium)bromide, poly(ionic liquids) including poly(1-vinyl-3-methylimidazolium)chloride, poly(4-vinylpyridium), polyelectrolytes including poly(allylamine) chloride/bromide, chitosan, chitin, amino/ammonium-molecules including ethylamine/propylamine/ethylenediamine, tetraalkylammonium salts, and combinations thereof.

The positively charged polymers (with high or low molecular weights, in linear or branched forms) could be, for example, polyethylenimine (PEI), chitosan, poly(1-vinyl-3-butylimidazolium) and polyvinylamine hydrochloride, combinations thereof, and the like. The polymer may be present in the solution at a concentration of from about 0.1 wt % to about 10 wt %, in embodiments from about 0.5 wt % to about 2 wt %. The membrane is then dried in an oven at a suitable temperature of from about 5° C. to about 200° C., in embodiments from about 50° C. to about 150° C., in embodiments about 100° C., for a suitable period of time, in embodiments from about 5 minutes to about 40 minutes, in embodiments from about 7 minutes to about 20 minutes, in embodiments about 10 minutes.

In other embodiments, the substrate and/or scaffold layers utilized to form a filter of the present disclosure may include negatively charged molecules such as carboxylate groups including sodium polyacrylate, sulfonate groups including poly(sodium 4-vinylstyrene sulfonate), nitrite groups including nitrocellulose, some small molecules including sodium acetate, sodium benzoate, terephthalic acid, benzene-1,3,5-tricarboxylic acid, 4-methylbenzenesulfonic acid, and combinations thereof.

The filters with these charged polymers were stable in water, implying that the filters could have a long life time (e.g., at least about 2 months).

In some embodiments, only a portion of the two layered membrane may be coated with a positively charged polymer. In this way, different portions of the surface of the membrane will have different charges and the membrane will be effective for water purification from different streams, which may have different pH values.

The performance of the filters according to the present disclosure meet all relevant safety standards, with a log reduction value of from about 4 to greater than about 6 for bacteria and a log reduction value of greater than 4 for viruses.

In embodiments, for a single filter of a scaffold layer and substrate layer without any ultra-fine nanofibers, the permeability of an electrospun membrane, having from about 40 to about 50 μm PAN thickness, may be 1260±30 (L/m² h/psi), with a log reduction value for B. diminuta bacteria is more than 4.

Such scaffold, having ultra-fine polysaccharide nanofibers described above, may exhibit a flux of 220±10 (L/m² h/psi) and a log reduction value of B. diminuta bacteria of about 6.

A double filter, including 2 scaffold layers as described herein, with each scaffold layer having a thickness of from about 40 to about 50 μm and with no ultra-fine polysaccharide nanofibers, may achieve more than 6 in log reduction value for B. diminuta bacteria.

With the polysaccharide nanofibers therein, a double filter with each scaffold layer having a thickness of from about 40 to about 50 μm achieves greater than 6 in log reduction value for B. diminuta bacteria.

For E. coli, a single filter with the scaffold layer having a thickness of from about 40 to about 50 μm and with no infused ultra-fine polysaccharide nanofibers, achieves a log reduction value of close to 6 logs for E. coli retention.

Single scaffolds of the present disclosure, having ultra-fine polysaccharide nanofibers described above, may exhibit a flux of 960±20 (L/m² h/psi) and a log reduction value of E. coli bacteria of about 6.

A double filter configuration, with each scaffold layer having a thickness of from about 40 to about 50 μm and with no polysaccharide nanofibers, achieves a log reduction value of close to 5 logs for E. coli retention. With the cellulose nanofibers included therein, a double filter with each scaffold layer having a thickness of from about 40 to about 50 μm achieves greater than 6 in log reduction value for E. coli bacteria.

A filter of the present disclosure (single layer) with a scaffold layer having a thickness of from about 40 to about 50 μm, and with polysaccharide nanofibers included therein, achieves a log reduction value of more than 4 for MS2. The log reduction value depends on the positively charged polymer coated on the surface of the membrane and the pH of the feed solution, so that when the feed solution has a pH of 8.5 and the membrane is coated with chitosan, the log reduction value for MS2 is under 1 logs. However, when the pH of the feed solution is about 6.5, the same membrane has a log reduction value of MS2 of more than 4. When the coating is poly(1-vinyl-3-butylimidazolim) bromide, the membrane achieved a log reduction value of more than 4 regardless of the pH of the feed solution.

As noted above, filters of the present disclosure may also be useful in removing dyes (e.g., Crystal Violet) and toxic/radioactive heavy metals from water. For example, filters of the present disclosure may have the capacity for adsorption of greater than about 68 mg of a dye/gram membrane, in embodiments from about 68 mg of a dye/gram membrane to about 100 mg of a dye/gram membrane, in embodiments from about 80 mg of a dye/gram membrane to about 90 mg of a dye/gram membrane.

Similarly, filters of the present disclosure may have the capacity for adsorption of greater than about 1.5 mg of a metal ion, such as Cr(VI), per gram membrane, in embodiments from about 1.5 mg to about 50 mg, in embodiments from about 10 mg to about 40 mg.

Similarly, filters of the present disclosure may have the capacity for adsorption of greater than about 167 mg of radioactive ion, such as UO₂²⁺, per gram cellulose nanofibers, in embodiments from about 167 mg to about 300 mg, in embodiments from about 200 mg to about 250 mg.

The following Examples are provided to illustrate, but not to limit, the features of the present disclosure so that those skilled in the art may be better able to practice the features of the disclosure described herein.

### Example 1

Procurement of materials. Polyacrylonitrile (PAN, with weight-averaged molecular weight of 1.5×10⁵ g/mol) was purchased from Aldrich. A poly(ethylene terephthalate) non-woven substrate (PET microfilter, AWA16-1, with an average fiber diameter of about 30 μm) was purchased from SANKO LIMITED, 1316-1 Kawamuko cho, Tsuzuki-ku, Yokohama, 224-0044 Japan. A non-woven PET micro filter (commercially available as NOVATEXX 2413, with an average fiber diameter of 20 μm, was purchased from Freudenberg Filtration Technologies KG, D-69465 Weinheim, Germany.

Cellulose (BIOFLOC 92 MV, wet, 22 wt % of wood pulp), was supplied by the Tembec Tartas factory in France. Cellulose nanofibers were prepared according to the procedure described in International Patent Publication No. WO2010/042647. B. diminuta and E. coli were purchased from ATTCC, and MS2 was incubated following the procedure below. MS2 bacteriophage was selected as a model for membrane retention test, because it is one of the smallest viruses, close in size and shape, and non-pathogenic. A single plaque MS2 (ATCC 15597-B1) was added into a tube containing 0.4 mL broth medium and placed 2 hours at 4° C. to elute phage. Then, 0.1 mL eluted phage was combined with 0.1 mL medium and 0.1 mL of 10 mM MgCl₂/10 mM CaCl₂, and incubated for 15 minutes at 37° C. The solution was transferred to 50 mL medium, and shaken vigorously for from about 6 hours to about 8 hours at 37° C. The solution was centrifuged for 10 minutes at 10,000 rpm at 4° C., and supernatant was filtered through a 0.22 μm filter (Millipore) to remove remaining residuals. Polyethylenimine (PEI), chitosan (branched with Mₙ˜20 KDa and Mₙ˜600 Da, respectively) were purchased from Aldrich and used without further treatment. Poly(1-vinyl-3-butylimidazolium) bromide (PVBIMBr) was synthesized in the lab.

### Example 2

Preparation of feed solution for bacteria and virus experiments. De-chlorinated water was spiked with B. diminuta (or E. coli) and MS2 phage and was stirred at room temperature. The concentration of the bacteria was from about 10⁴ to about 10⁶ colony forming units per milliliter (cfu/mL).

Another type of feed solution could be prepared with organic content, such as humic acid or tannic acid, and dissolved solids such as sea salts or sodium chloride, in order to more closely imitate the composition of real-world water supplies. The presence of this dissolved and suspended matter will adversely affect the ability of the filter to remove virus and ionic substances.

### Example 3

Preparation of the nanofibrous scaffolds. The electrospun nanofibrous scaffolds were prepared by using a multiple-jet electrospinning apparatus with 8 wt % of PAN-DMF solution. They were applied to either the AWA16-1 PET microfilter, or the NOVATEXX 2413 non-woven PET microfilter. The resulting membranes were denoted PAN/AWA or PAN/JP (for the PAN/AWA16-1 PET microfilter combination) or PAN/NOVATEX 2413 (for the PAN/NOVATEXX 2413 non-woven PET microfilter). The samples were punched into 47 mm diameter discs and sanitized with 5 parts per million (ppm) of sodium hypochlorite or 70 wt % of isopropanol aqueous solution before the bacteria/viruses test.

### Example 4

Bubble point testing. The bubble point and pure water flux for different thicknesses of the scaffold layer were measured with custom-built devices. Bubble point tests provide an indication of the maximum pore size of the filter. All data were collected and repeated by 3 duplicated samples. 47 mm ADVANTEC filter holders or MILLIPORE 47 mm inline plastic filter holders were employed for the flux/bubble point tests.

The bubble point test was carried out as follows:

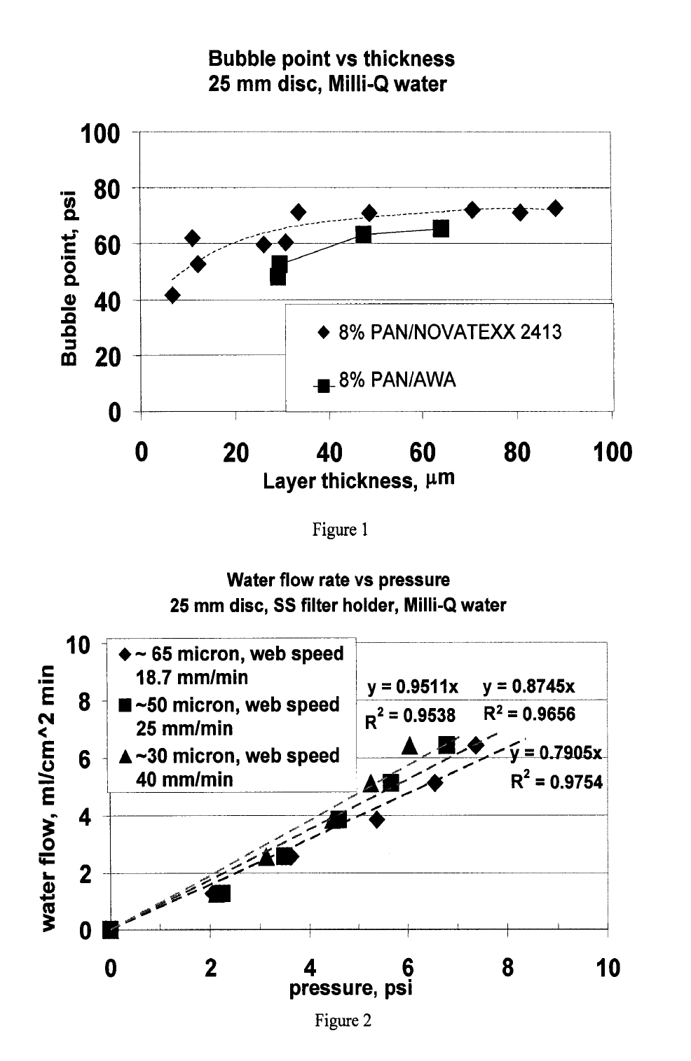

(a) Install the sample (25 mm disc) in the membrane holder (SS filter holder (Millipore) and wet the membrane with pure water (Milli-Q water) using a syringe.
(b) Allow a small amount of water passing through the membrane to make sure that the membrane surface is completely wet and the air is removed from the porous structure. Always leave some water inside the membrane holder so as to have a liquid layer on the top of the membrane (electrospun layer).
(c) Assemble the membrane holder, pressure gauge, T-connector and connect it to a gas cylinder (compressed Nitrogen), with the e-spun layer facing up to the pressure inlet.
(d) Pressurize the system to about 80% of expected bubble point pressure and slowly increase the pressure until rapid continuous bubbling is observed at the outlet. (Ignore the first few bubbles during the initial pressurization.)
(e) Measure at least 3-5 samples for the same membrane and average the data points. The bubble point vs. thickness of the PAN/AWA and PAN/NOVATEXX 2413 membranes were determined. The results are shown in FIG. 1. A plateau was observed when the thickness of the PAN e-spun layer was more than 30 μm, implying that the average pore size reached a limiting value when the thickness approached a certain value.

### Example 5

Water flux testing. Pure water (MILLI-Q, MILLIPORE) was employed to determine the effects of the e-spun membrane thickness on the water flux, where the thickness of the membrane could be controlled by the moving speed of the collector during the electrospinning process.

From FIG. 2, it can be seen that the PAN/AWA with a 30 μm thickness had a higher water flux. However, the PAN/AWA membrane with a 50 μm thickness was a better candidate for the production of the MF filters, considering a combination of other factors, such as the spinnability, reproducibility, bubble point, and water flow rate of e-spun membranes.

### Example 6

Stability testing. The stability of PAN/AWA e-spun membranes was tested with isopropanol (IPA) because IPA is broadly used in the filtration industry, either to disinfect products and parts or to quantify products performance. Two concentrations of IPA in Milli-Q water solutions, which are commonly used in the pharmaceutical industry to decontaminate work areas, were employed to determine the stability of PAN/AWA e-spun membranes. The changes of physical dimension (thickness), bubble point, as well as pure water flux were investigated.

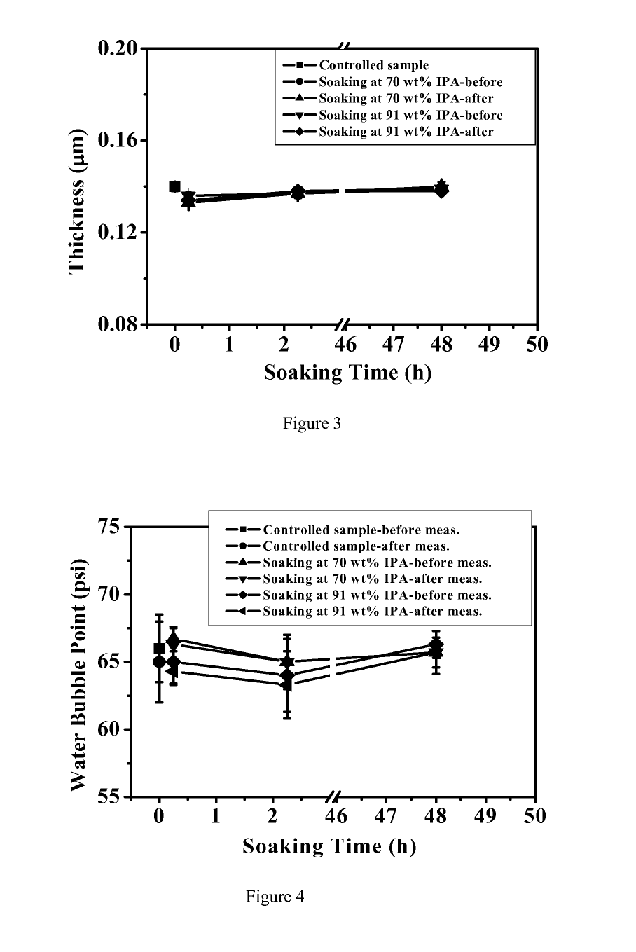

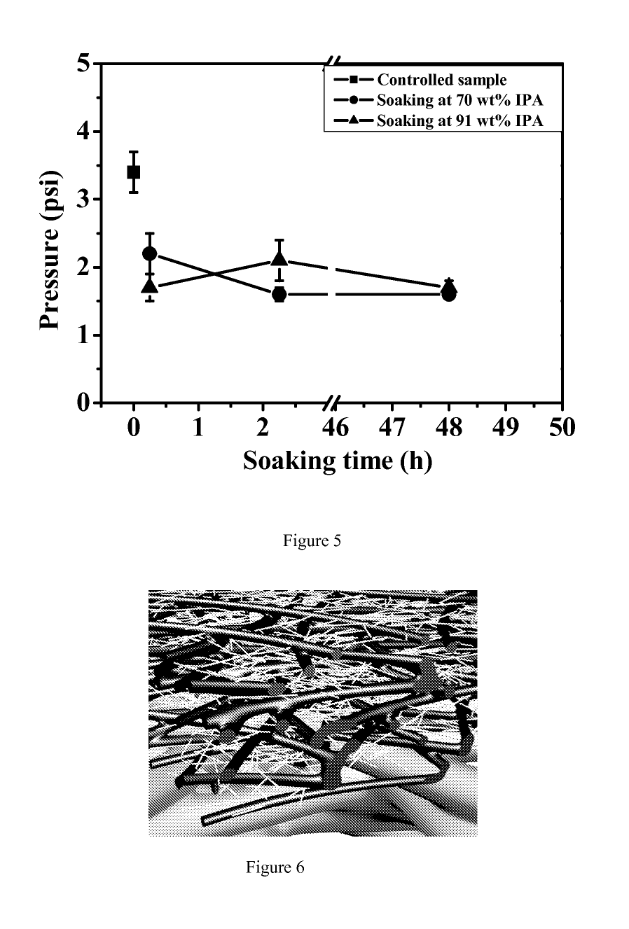

47 mm discs (3 discs each) were used to determine the stability of the PAN/AWA membrane in IPA aqueous solutions. The sample was latched in the filter holder (47 mm, Millipore) and Milli-Q water was employed for the test. The water flow rate was 60 mL/minute, and the temperature was kept at 25.5±0.5° C. The thickness of the membrane vs. testing time is shown in FIG. 3.

The thickness of the membrane was measured in the wet state. A change in thickness of <7 μm during the experiment was attributed to the fact that the PAN/AWA e-spun membrane was very stable in IPA/water solutions (either 70 wt % or 91 wt %) without obvious swelling after a 48 hour soaking. Thus, IPA/water solution could be another candidate for sanitizing PAN/AWA MF filters before the bacteria/virus tests.

### Example 7

To further determine the affect of IPA solution on the structure of the PAN/AWA e-spun membrane, the bubble point data were measured before and after sanitizing for 48 hours, as shown in FIG. 4.

The initial bubble point before sanitizing was 66.0±2.5 psi, while that of the samples soaked in IPA/water after 48 hours was 65.7±1.6 psi. The bubble point value changed less than 2 psi which was within the precision of the measurement. Moreover, the bubble point value was also unchanged before and after flux measurements, implying that the mechanical properties of the membrane were less affected by IPA/water solutions up to 48 hours.

### Example 8

Pressure drop testing. The pressure drop of the PAN/AWA membrane was investigated before and after sanitizing with IPA/water for 48 hours, as shown in FIG. 5.

The pure water flux was fixed at 60 mL/minute during the experiment and the pressure drop was measured. After 48 hours sanitizing, the pressure drop changed within 0.6 psi, which also matched the error bars of the measurement. In summary, the IPA/water solution sanitized the PAN/AWA e-spun membrane before the evaluation of the bacteria/virus reduction capacity.

### Example 9

Preparation of cellulose nanofiber (CN) modified PAN/AWA membranes. Cellulose nanofiber aqueous solutions, with different concentrations (from 0.01 wt % to 0.30 wt %), were applied to the PAN/AWA membranes produced above in Example 3. Specifically, the PAN/AWA membrane discs were latched into the holders (47 mm), making sure that the PET layer was downstream to the screen of the holder. The cellulose nanofiber solution was infused into the filter by adding pressure (˜2 psi) with a gas tank. After loading enough cellulose nanofibers (depending on the concentration and amount of suspension), the filter was taken out and dried in an oven at 100° C. for 20 minutes. The resulting membrane or filter may be referred to, in embodiments, as a PAN-CN/AWA membrane.

### Example 10

Positively charged polymer modification. The further modification of PAN-CN/AWA membrane with positively charged polymers was carried out by dip-coating the membrane in an aqueous solution, including polyethylenimine (PEI, 2.0 wt %), chitosan (0.2 wt %), or poly(1-vinyl-3-butylimidazolium)bromide (PVBIMBr, 0.2 wt %), with predetermined concentrations. After that, the membrane was dried in an oven at about 100° C. for about 10 minutes.

Introduction of positive charges on cellulose nanofibers was also carried out by grafting chelating groups, including amino groups such as polyethylenimine and diamine, and/or sulfhydryl groups such as cystine and thiazolidine, in the reaction catalyzed by 1-ethyl-3-(3-dimethylaminopropyl)carbodiimide hydrochloride (EDC) and N-hydroxysuccinimide (NHS). After the modification, the modified cellulose nanofiber suspension was infused into the PAN electrospun layer to reach a desired loading density.

### Example 11

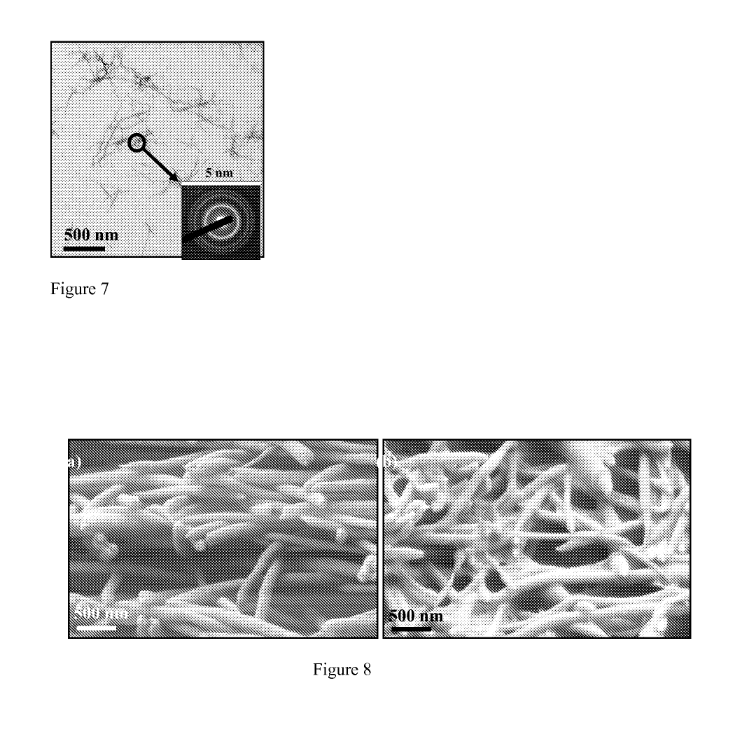

Morphology of cellulose nanofibers. A transmission electron microscope (TEM) (a FEI BioTwinG2) equipped with an AMT digital camera, as well as with film capability, operating at an accelerating voltage of 120 kV, with goniometer/stage tilt capability, was used to acquire the micrographs. The samples were prepared by coating a grid (Ted Pella, Inc.) with 0.01 wt % aqueous cellulose nanofibers suspension, followed by staining with a 2 wt % aqueous uranyl acetate solution. FIG. 7 shows that the prepared cellulose nanofibers had diameters of 5˜10 nm and lengths of 200˜400 nm. The electron diffraction pattern of the cellulose nanofibers probed by TEM showed cellulose I crystals. The amount of carboxylate and aldehyde groups were 1 and 0.3 mmol/gram cellulose, respectively, according to the titration experiments (see Example 16 below).

### Example 12

Morphology of cellulose nanofiber impregnated nanocomposite membrane. A scanning electron microscope (SEM) (a LEO 1550) equipped with a Schottky field emission gun (10 kV) and a Robinson backscatter detector was used for the SEM micrographs in both cross-sectional and top views. The cross-sectioned samples were prepared by freeze-fracturing the water-wetted membrane in a liquid nitrogen bath. The nanocomposite membrane disclosed in this Example was based on a non-woven structure of electrospun PAN nanofibers, deposited onto a PET non-woven microfiber substrate, where the cellulose nanofibers were impregnated into the PAN nanoscaffolds matrix, as shown in FIGS. 8 (a) and (b). It is noted that the cellulose nanofibers were collapsed onto the surface of the PAN nanofibers, forming an entangled, partially bundled, and partially cross-linked mesh anchored on the PAN surface. Compared to the undecorated PAN nanoscaffold, this structure exhibited a substantial increase in the effective surface-to-volume ratio of the nanofibrous membrane, as well as an improvement of the mechanical properties of the electrospun scaffolds, as confirmed by tensile strength tests (described in greater detail in Example 14 below).

### Example 13

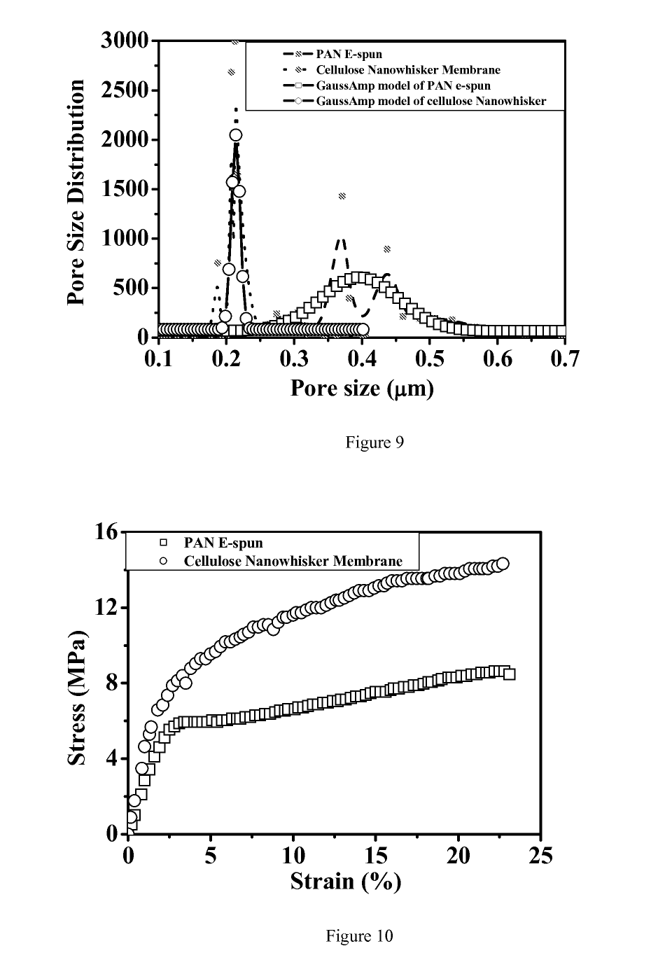

Pore size distribution. The pore size distribution was measured using a capillary flow porometer (FPA-1500A, from Porous Materials Inc., USA). A wetting fluid GALWICK™ (from Porous Materials Inc.) with a surface tension of 15.9 dynes/cm was used to wet the membrane. The mean pore size of the PAN electrospun nanoscaffold was 0.38 μM, and a broad distribution of pore sizes was observed (See FIG. 9). After impregnation with cellulose nanofibers, the mean pore size of the membrane decreased to 0.22 μm, and the distribution became quite narrow.

### Example 14

Tensile Stretching. All samples were uniaxially stretched at room temperature using a modified Instron 4442 tensile apparatus under symmetric deformation. The initial length between the Instron jaws was 10 mm and the stretching rate was 5 mm/minute. The mechanical properties of the cellulose nanofiber membrane were significantly improved compared to those of the PAN/PET membrane, as shown in FIG. 10. No yield point was observed during tensile stretching of the cellulose nanofiber composite membrane. The Young's modulus and the ultimate tensile strength were 375±15 and 14.3±0.4 MPa, respectively, which were increased by close to a factor of 2 when compared with the undecorated electrospun nanoscaffolds (226±20 and 8.5±0.3 MPa). This is strong evidence for the stabilization of the cellulose nanofiber mesh by cross-linking, in agreement with the SEM images and models. Curiously, the elongation to break (˜23.0±3.0%) did not change significantly.

### Example 15

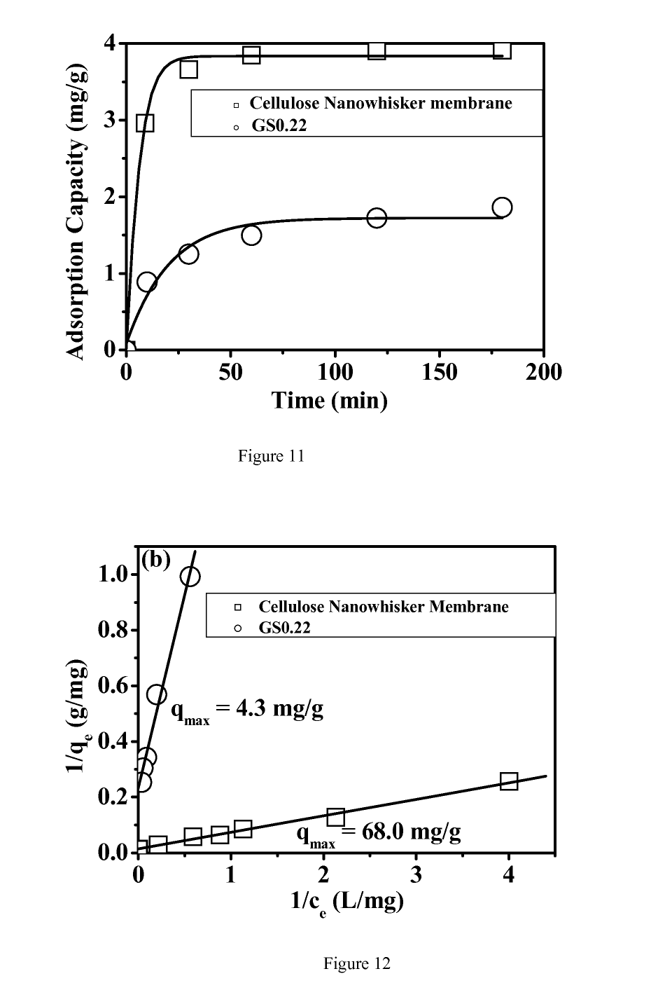

Adsorption capacity and water contact angle. The adsorption capacity of Crystal Violet (CV) in the nanofibrous microfiltration (MF) membrane was measured batch-wise. About 0.05 grams of cellulose nanofiber membrane from Example 9 and of a commercial mixed cellulose esters membrane (sold as GS0.22 by Millipore), respectively, were immersed in about 20 mL CV aqueous solution (10 mg/L, pH=7.0) on a shaking bed for a period of about 180 minutes at about 20° C. The amount of the CV adsorbed onto the membrane was calculated from the concentration change of the CV solution before and after the adsorption, as determined by optical absorption at 590 nm. The CV adsorptive capacity as a function of time was determined, as shown in FIG. 11. After 2 hours, the concentration of CV reached an equilibrium, and the adsorption of CV onto the cellulose nanowhisker membrane was saturated. The adsorption capacity was assumed to have reached the maximum level under this condition.

The maximum adsorption capacity of the nanofibrous membrane as well as the commercial GS0.22 membrane was investigated by using Langmuir adsorption isotherms. About 0.03 grams of membranes were immersed into 10 mL of CV solutions at different concentrations ranging from 5 mg/L to 1000 mg/L and shaken for 2 hours at 20° C. An analysis of the relationship between the adsorption capacity of membranes and the CV concentration was performed using the Langmuir adsorption equation.

1/qₑ=1/qₘ+k_{d}/qₘ×(1/cₑ) (1)

where qₘ is the maximum adsorption at monolayer coverage (mmol·g⁻¹) and k_{d} is the Langmuir adsorption equilibrium constant (L/mg), reflecting the energy of adsorption.

The adsorption of CV onto the cellulose nanofiber nanocomposite membrane was rapid when compared with that of GS0.22. This feature should be beneficial for dynamic adsorption in real applications. At 10 mg/L CV aqueous solution, the approach to equilibrium occurred after 0.5 hours. The reason could be the hydrophilic surface of the electrospun nanofibers, modified by the cellulose nanofiber where water goes through easily. As evidence, the water contact angle of cellulose nanofiber membrane was 16.9° (the contact angle of PAN/PET membrane was 50.6°), while that of GS0.22 was 56.3°.

After 2 hours, all membranes reached the equilibrium status in the solution. Moreover, the equilibrium concentration of unadsorbed CV of the cellulose nanofiber nanocomposite membrane was significantly lower, as indicated by a 3-times higher adsorption capacity than that of GS0.22 (see FIG. 11).

Adsorption isotherms of the membranes were further investigated by using different concentrations of CV solutions, and the maximum adsorption capacity of the membranes was obtained from the Langmuir adsorption equation, as shown in FIG. 12. The Langmuir isotherm model assumes a monolayer adsorption onto the surface with a finite number of identical sites, with all sites being energetically equivalent and no interaction between adsorbed molecules. All points showed a linear relationship and a deviation R²>99.3%, which confirmed that the adsorption process obeyed first order dynamics. It was found that the maximum adsorption capacity of cellulose nanofiber nanocomposite membranes for CV was 16-times higher than that of GS0.22, which supports the concept of a very high surface-to-volume ratio of the membrane.

### Example 16

Surface charge density. Considering the equimolar interaction between carboxylate groups in the cellulose nanofibers and amino groups in the CV, the surface charge density of the cellulose nanofiber nanocomposite membrane could be estimated based on the maximum adsorption capacity of the membrane.

A conductivity titration experiment was carried out to determine the effective amount of carboxylate groups on the surface of the membrane. About 0.18 grams of cellulose nanofiber membrane was suspended in 70 mL water, and the suspension was acidified with concentrated HCl (36.5%) to pH 2. A sodium hydroxide standard aqueous solution (0.02 mol/L) was used to titrate the solution to pH=10.4, while monitoring the conductivity during the titration process.

The conductivity and pH curves showed the presence of strong acid (excess HCl) and weak acid, which corresponded to the content of carboxyl groups on the surface of the membrane. The surface charge density was then calculated by the content of carboxyl groups (equal molar to the negative charges) normalized by the weight of the membrane. The surface charge density of the membrane calculated based on the adsorption approach was 0.17 mmol/(g membrane), matching well with the 0.22 mmol/(g membrane) as determined by the titration experiment.

### Example 17

Zeta potential. The zeta potential of the membrane was determined with a SurPASS electrokinetic analyzer (Anton Paar Company) based on a streaming potential and streaming current measurement. This instrument includes an analyzer, a measuring cell, electrodes, and a data control system. For each measurement a sample with dimensions of 10 mm×20 mm was carefully affixed on to each of the two sample holders using double sided adhesive tape. The sample holders were inserted into the adjustable gap cell (AGC) and the gap between the samples adjusted to 50-150 μm. The measuring heads with Ag/AgCl electrodes were then attached to the AGC. A maximum pressure of 300 mbar was specified and a linear relation between pressure and flowrate was achieved. A background electrolyte of 1 mM KCl solution was prepared in DI water.

Each sample was first rinsed at a maximum pressure of 300 mbar for 180 seconds before the streaming current was measured at a target pressure of 300 mbar for 20 seconds. The measurement of streaming current was performed in both flow directions after rinsing the samples sufficiently with the electrolyte solution. Equipped with the auto-titration capability, the zeta potential variation with pH was estimated, and was calculated according to the Helmholtz-Smoluchowski equation:

ξ=(dI/dP)×[η/(∈×∈₀)]×(L/A) (2)

where dI/dP was the slope of streaming current versus differential pressure, η was the electrolyte viscosity, ∈ₒ was the permittivity, c is the dielectric coefficient of electrolyte, L was the length of the streaming channel, and A was the cross-section of the streaming channel.

The Zeta potentials of the membrane were from −70.8 mV to −80.4 mV when the pH value of the system changed from 5.4 to 8.9. At pH 7.0, the zeta potential of −75.2 mV was very negative, which provided further strong evidence for the high adsorption capacity of the cellulose nanowhisker nanocomposite membrane for positively charged species.

### Example 18

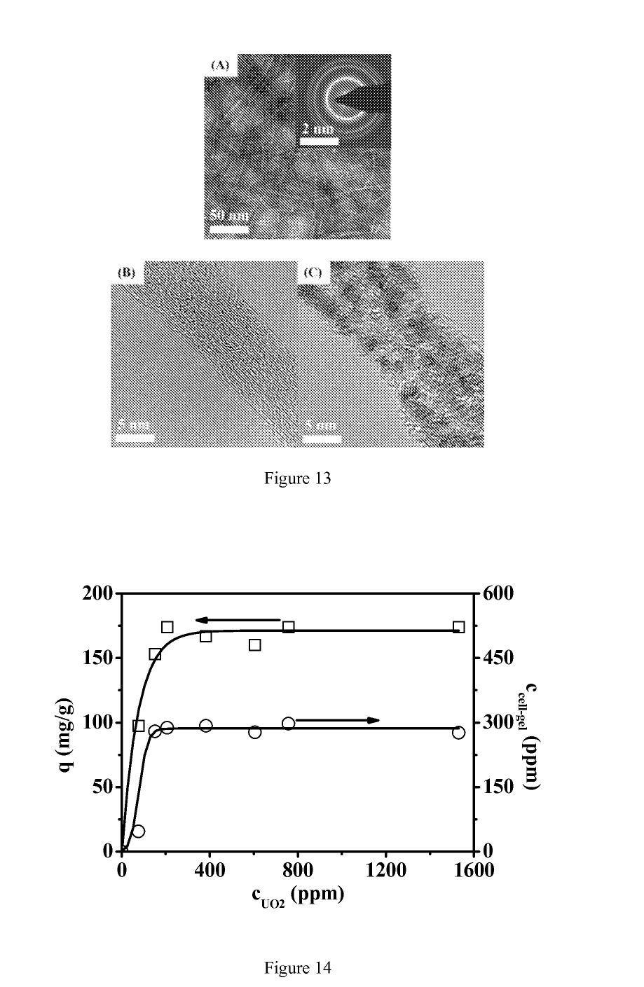

Morphology of ultra-fine cellulose nanofibers before and after adsorption of uranyl ions. The surface morphologies of cellulose nanofibers before and after adsorption of uranyl ions (UO₂²⁺)were taken with an aberration corrected electron microscope operated at 80 kV (FEI Titan 80-300, corrected up to third-order aberration). To avoid radiation damage of cellulose nanofibers, only 0.1 seconds to 0.5 seconds of exposure time were permitted. The images are shown in FIGS. 13 A-C.

The diameter of the cellulose nanofibers was from 5 nm to 10 nm, as determined by high resolution TEM. (See FIG. 13A.) Again, the insert shows a typical electron diffraction pattern of ultra-fine cellulose nanofibers attributed to cellulose type I crystals, which confirm that the oxidation occurred primarily on the surface, particularly at the amorphous regions of cellulose nanofibers. From the high resolution TEM image of FIG. 13B, individual chains of cellulose nanofibers with fingerprint-like configuration were clearly visible. After the adsorption of UO₂²⁺, the surface of cellulose nanofibers became covered with metal ionic crystals as evidenced by the crystal lattice (see FIG. 13C), a direct proof that cellulose nanofibers could adsorb a large amount of UO₂²⁺.

### Example 19

Adsorption of radioactive UO₂²⁺. To further explore the adsorption capacity of ultra-fine cellulose nanofibers for UO₂²⁺, a series of static adsorption experiments was carried out with an aqueous suspension of 0.05 wt % cellulose nanofibers (determined by total organic carbon (TOC) analysis). Uranyl acetate aqueous solutions with UO₂²⁺concentrations of 1530 ppm, 760 ppm, 610 ppm, 380 ppm, 210 ppm, 150 ppm, and 80 ppm (determined by UV-vis spectroscopy at 420 nm) were added into the cellulose nanofiber suspension under vigorous stirring. After 2 hours, the gel-like cellulose nanofibers adsorbed with UO₂²⁺ were removed by filtering with 1.0-μm filter paper (Whatman) and 0.1-μm PVDF filter (Millipore), separately.

A gel was formed immediately following the addition of UO₂²⁺ ions to the cellulose nanofiber suspension, possibly caused by the coordination complex formation between UO₂²⁺ and carboxylate groups located on the surface of ultra-fine cellulose nanofibers, where UO₂²⁺ ions act as a “cross-linker” to form aggregates. The gelation threshold occurred when UO₂²⁺ concentrations were below 150 ppm, as confirmed by different equilibration concentrations of cellulose nanofibers measured with the TOC analyzer after filtration. A 1.0-μm filter was able to remove the gel component formed by cellulose nanofibers with UO₂²⁺ in the cellulose nanofiber suspension. Therefore, when 80 ppm of UO₂²⁺ were added to the cellulose nanofiber suspension, the equilibrated carbon concentration, as determined by TOC, was 140 ppm, while the total carbon concentration from both cellulose nanofibers and acetate ions of uranyl acetate, would theoretically be 162 ppm. On the other hand, the suspension after filtration with a 0.1 μm filter membrane could eliminate all cellulose nanofibers, independent of gel formation. The results are graphically depicted in FIG. 14.

The TOC of the equilibrated carbon concentration after filtration with a 0.1 μm filter became 21 ppm, which was mainly from the acetate ions. It was calculated that only 22 ppm carbon concentration (corresponding to 50 ppm of cellulose nanofibers defined as C_{cell-gel} in FIG. 14) formed gels under this condition. This result suggests an adsorption mechanism of the coordination between UO₂²⁺ and carboxylate groups located on the surface of cellulose nanofibers, while the acetate ions were left in the equilibrium suspension after filtration. With further increase of the UO₂⁺ concentration to 210 ppm, the amount of gel approached a maximum value of 288 ppm; yet it remained the same when the concentration of UO₂²⁺ was increased further. Also, the adsorption capacity (qₘₐₓ) calculated from the difference between the original and the equilibrium concentration of UO₂²⁺ (determined by UV-vis after filtration with 0.1 μm filter) was 167 mg/g cellulose nanofibers. These results showed a vivid correlation between the content of carboxylate groups of cellulose nanofibers and the UO₂²⁺ adsorption capacity. Furthermore, the content of carboxylate groups distributed on the surface of cellulose nanofibers was 1.4 mmol/g cellulose nanofibers according to titration measurements. The coordination ratio between UO₂²⁺ and carboxylate groups would be expected to be 1:2. Therefore, 190 mg of UO₂⁺ should be adsorbed by 1.0 g of cellulose nanofibers, corresponding to the maximum adsorption capacity of UO₂²⁺ when compared with 167 mg/g cellulose nanofiber. The current estimate also confirms that the adsorption mechanism is mainly based on the coordination of UO₂²⁺ with the carboxylate groups by chelation.

### Example 20

Membrane testing. The PAN/AWA e-spun membrane (with different thicknesses of the PAN layer) from Example 3, without infused cellulose nanofibers or any further modification, was employed to eliminate bacteria, B. diminuta, from water, and the results are shown in Table 1.

TABLE 1
Retention of B. diminuta of PAN/AWA
e-spun membranes at different
PAN thicknesses of the barrier layer

| | Thick- | | | | | | | |
|---|---|---|---|---|---|---|---|---|
| | ness | | | | Concen- | LRV | | |
| | of | Bub- | | | tration | for | | |
| | PAN | ble | Pressure | | of B. | B. | | |
| Sam- | barrier | Point | drop | Flux | diminuta | dim- | | Temp. |
| ple | (μm) | (psi) | (psi) | (L/m²h) | (cfu/mL) | inuta | pH | (° C.) |
| 1 | 45 ± 5 | 52 ± 4 | 3.4 ± 0.3 | 4290 ± | 2.5 × 10⁵ | >4 | 6.5 | 20 ± 2 |
| | | | | 100 | | | to | |
| | | | | | | | 8.5 | |
| 2 | 95 ± 5 | 68 ± 1 | 3.2 | 2880 ± | >10⁶ | >6 | 6.5 | 20 ± 2 |
| | | | | 90 | | | to | |
| | | | | | | | 8.5 | |

The permeability of the PAN/AWA e-spun membrane with 45 μm PAN thickness was 1260±30 L/(m² h/psi), while the log reduction value was more than 4. Further increasing the thickness of the PAN barrier decreased the flux to 900±28 L/(m² h/psi) while the retention approached 6 logs, which indicated that the PAN/AWA membrane could be used for the filtration of bacteria-contaminated water with fairly high permeation flux and low pressure drop.

### Example 21

Membrane testing. A filter including two separate PAN/AWA e-spun filters, with the PAN layers being held face to face and latched into the stainless steel holders, was tested for bacterial removal. This method not only improved the LRV for bacteria, but also protected the MF barrier by the PET(AWA) layer facing the feed solution. In some samples, cellulose nanofibers were introduced to infuse into the barrier layers as described above in Example 9. The results are shown in Table 2.

TABLE 2
Retention of B. diminuta of PAN-CN/AWA
e-spun membranes with a
double (face to face) barrier layer

| | Thick- | | | | | | | |
|---|---|---|---|---|---|---|---|---|
| | ness | | | | Concen- | LRV | | |
| | of single | | | | tration | for | | |
| | PAN | Bubble | Pressure | | of B. | B. | | |
| | barrier | Point | drop | Flux | diminuta | dim- | | Temp. |
| Sample | (μm) | (psi) | (psi) | (L/m²h) | (cfu/mL) | inuta | pH | (° C.) |
| 3# | 45 ± 5 | 67 ± 1 | 3.2 ± 0.5 | 2880 ± | >10⁶ | >6 | 6.5 | 20 ± 2 |
| | Without | | | 90 | | | to | |
| | CN | | | | | | 8.5 | |
| 4# | 45 ± 5 | 67 ± 1 | 3.5 ± 1 | 2880 ± | >10⁶ | >6 | 6.5 | 20 ± 2 |
| | with | | | 90 | | | to | |
| | CN | | | | | | 8.5 | |

The PAN/AWA fibers with or without CN had about the same retention for B. diminuta, however, after deposit of cellulose nanofibers, the pressure drop was increased slightly.

### Example 22

Membrane testing. E. coli was employed as well as B. diminuta to challenge the PAN/AWA e-spun filters with single and double layer structures, respectively, without CN. The results are shown in Table 3.

TABLE 3
Retention of B. diminuta and E. coli of
PAN/AWA e-spun membranes with single
or double barrier layers (without CN)

| | | | | | Concen- | | | | |
|---|---|---|---|---|---|---|---|---|---|
| | Thick- | | | | tration | LRV | | | |
| | ness | | | | of B. | for | LRV | | |
| | of PAN | Bubble | Pressure | | diminuta or | B. | for | | |
| | barrier | Point | drop | Flux | E. coli | dim- | E. | | Temp. |
| Sample | (μm) | (psi) | (psi) | (L/m²h) | (cfu/mL) | inuta | coli | pH | (° C.) |
| 5# | 45 ± 5 | 58 ± 1 | 3.0 | 8928 | >10⁵ | >5.8 | >5.4 | 6.5 | 20 ± 2 |
| | Single | | | | | | | to | |
| | | | | | | | | 8.5 | |
| 6# | 45 ± 5 | 58 ± 1 | 3.0 | 2736 | >10⁵ | 4.2 | 4.8 | 6.5 | 20 ± 2 |
| | double | | | | | | | to | |
| | | | | | | | | 8.5 | |

As can be seen from the above, the PAN/AWA e-spun membrane had full retention for both E. coli and B. diminuta, even with the single barrier layer, where the water permeability was also as high as 2980 L/(m² h/psi), which was 3 times higher than that of the double layer structure.

### Example 23

Membrane testing for filtering viruses. Cellulose nanofibers of about 5 nm in diameter and about 200 nm in length were prepared and infused into the PAN/AWA barrier as described in Example 9. The composition of the MS2 solution was deionized (DI) water, about 500 parts per million (ppm) TDS (sea salts), and from about 10⁴ to about 10⁶ cfu/mL of MS2.

As noted above, the pH value of the virus solution will seriously affect the adsorption. At pH values lower than the isoelectric point (pI) of the virus, the virus could coagulate together which would increase the effective size of the virus to a few microns. For practical applications, high pH values (around neutral or higher) might be desirable.

Considering that the isoelectric point of MS2 is 3.9 for virus solutions at high pH values (e.g., 6.5˜8.5), the filter membrane with positively charged surface would be better suited to adsorb MS2, since MS2 is negatively charged under such conditions.

The cellulose nanofibers have natural negative charges produced from the oxidation process, i.e., oxidation of wood pulps with TEMPO/NaBr/NaClO aqueous system followed by mechanical treatment. The charged density of the cellulose nanofibers was as high as 0.70 mmol/g cellulose.

### Example 24

PEI was used first to modify cellulose nanofibers. The PAN-CN/AWA membrane was dipped into 2 wt % of PEI solution for a few seconds and the membrane was dried at 100° C. for 10 minutes. The PEI modified PAN-CN/AWA filter was used to adsorb MS2 at different pH values, as shown in Table 4.

TABLE 4
Retention of MS2 of PEI modified PAN-CN/AWA
e-spun membranes (single layer)

| | Thickness | | | | | |
|---|---|---|---|---|---|---|
| | of | Pressure | | LRV | | Temp- |
| | PAN barrier | drop | Flux | for | pH | erature |
| Sample | (μm) | (psi) | (L/m²h) | MS2 | value | (° C.) |
| 7# | 45 ± 5 | 0.28 ± 0.04 | 192 | >4 | 6.5 | 20.5 |
| 8# | 45 ± 5 | 0.18 ± 0.02 | 192 | >4 | 8.5 | 20.5 |

High flux and low pressure drop of PEI modified PAN-CN/AWA MF membrane was achieved, as set forth in Table 4 above. The retention of the membrane for MS2 seemed to be less affected by changes in the pH value.

### Example 25

A chitosan modified membrane was prepared similar to the PEI modified membrane of Example 24, with chitosan applied at a concentration of 0.2 wt %, instead of PEI. It should be noted that some of the filter surface modifications could be affected by the pH values of the virus solution. For example, chitosan has positive charges when the pH value is 6.5. However, less or no charge would be observed for chitosan when the pH value was increased to 8.5 in the solution. Thus, chitosan modified PAN-CN/AWA had full retention for MS2 at pH 6.5 but <1 log when the pH value was increased to 8.5 (Table 5).

TABLE 5
Retention of MS2 of chitosan modified PAN-CN/AWA
e-spun membranes (single layer)

| | Thickness | | | | | |
|---|---|---|---|---|---|---|
| | of | Pressure | | LRV | | Temp- |
| | PAN barrier | drop | Flux | for | pH | erature |
| Sample | (μm) | (psi) | (L/m²h) | MS2 | value | (° C.) |
| 9# | 45 ± 5 | 0.48 ± 0.01 | 192 | >4 | 6.5 | 20.5 |
| 10# | 45 ± 5 | 0.46 ± 0.04 | 192 | <1 | 8.5 | 20.5 |

### Example 26

Poly(1-vinyl-3-butylimidazolium)bromide (PVBIMBr), was synthesized and used to modify the cellulose nanofibers following the process utilized with PEI in Example 24 above, with PVBIMBr applied at a concentration of 0.2 wt %, instead of PEI. Instead of amino groups, the imidazolium cation, which is expected to be affected less by pH changes, was employed in the polymer chains, as listed in Table 6.

TABLE 6
Retention of MS2 of PVBIMBr modified PAN-CN/AWA
e-spun membranes. (single layer)

| | Thickness | Pres- | | | | |
|---|---|---|---|---|---|---|
| | of PAN | sure | | LRV | | Temp- |
| | barrier | drop | Flux | for | pH | erature |
| Sample | (μm) | (psi) | (L/m²h) | MS2 | value | (° C.) |
| 11# | 45 ± 5 | 0.36 | 192 | >4 | 6.5 | 20.5 |
| 12# | 45 ± 5 | 0.41 | 192 | >4 | 8.5 | 20.5 |

### Example 27

Membrane testing for toxic metal adsorption. PAN membranes with and without diamine-modified cellulose nanofibers were measured for metal binding properties, using the National Institute for Occupational Safety and Health (NIOSH) manual of analytical methods 7600. A chromium solution (1 mg/L) was made by diluting a standard K₂CrO₄ solution purchased from Sigma. About 5 mL of suspension was filtered through the filters at a constant pressure (2 psi) and room temperature (22° C.), and the permeation flux was measured. The dynamic adsorption rate of chromium (VI) was calculated by the ratio of weight of metal ions over that of cellulose nanofibers.

TABLE 7
Adsorption of Cr (VI) of diamine modified PAN-CN/AWA
e-spun membranes. (single layer)

| | Thick- | Diamine | | | | | |
|---|---|---|---|---|---|---|---|
| | ness | cellulose | | | CrO₄²⁻ | | |
| | of | nanofiber | | | ad- | | |
| | PAN | loading | Pres- | Flux | sorp- | | Temp- |
| | barrier | amount | sure | (L/m²h/ | tion | pH | erature |
| Sample | (μm) | (mg/cm²) | (psi) | psi) | (mg/g) | value | (° C.) |
| 13# | 100 ± 20 | 0 | 2.0 | 1300 | 0 | 5.0 | 22 ± 3 |
| 14# | 100 ± 20 | 0.2 ± 0.05 | 2.0 | 800 | 1.5 | 5.0 | 22 ± 3 |

As can be seen from the above, high flux and low pressure drop nanofibrous microfiltration (MF) membranes were fabricated using a non-woven composite structure format containing electrospun nanofibrous scaffold (e.g. polyacrylonitrile (PAN) and polyethersulfone (PES) electrospun nanofibers) on mechanically strong substrate (e.g. polyethylene terephthalate (PET) non-woven), where the composite was infused with ultra-fine polysaccharide nanofibers (e.g., cellulose, chitin, etc) in both layers. This composite format was effective to remove bacteria (e.g., B. diminuta and E. coli) and viruses (e.g., MS2) in water reservoirs of drinking water from lakes, rivers, and ponds. We demonstrated that high retentions of bacteria (>6 log reduction value (LRV)), viruses (>4 LRV), toxic metal ions (CrO₄²⁻ of about 1.5 mg/gram), and radioactive metal ions (UO₂²⁺ of about 167 mg/(gram cellulose nanofibers)) could be simultaneously achieved using such composite filters while maintaining a low pressure drop at 0.3˜0.5 psi (i.e., 192 L/m² h of flux) within a wide pH range (3.5 to 8.5 or even high). The permeation fluxes of these filters were significantly higher (5-7 times) than those of conventional commercial MF filters under the same pressure (e.g., 2 psi); the pressure drop of these filters were also significantly lower than those of conventional commercial MF filters under the flow rate.

The nanofibrous MF membrane could be easily scaled up due to the demonstrated mass production capability of electrospun membrane and the simple process for incorporation of polysaccharide nanofibers. Moreover, the fabrication cost could be low as only water is used as the medium for this process, minimizing the environmental concerns.

Advantages of these high flux and low pressure drop MF membranes include, but are not limited to, the following:

(1) The high porosity and the nanofibrous structure of the electrospun membrane could yield high flux with low pressure drop, implying that a simpler lower cost energy-saving purification system could be realized;

(2) The polysaccharides nanofibers, including cellulose and chitin, have ultra-fine fiber diameters (˜5 nm), which not only increase the effective specific surface area of the functional components of the filter, but can also provide a platform to functionalize the very large specific surface areas of the nanofibers to adsorb viruses as well as to partially exclude viruses due to the unique non-woven structures of the nanofibers;

(3) The surface charges of MF membranes could be easily exchanged from negative to positive, or a judicious combination of positive and negative charges in separate locations, to tailor design adsorption of different viruses;

(4) The fabrication of MF membranes could be easily scaled up with electrospinning, and the production cost of ‘green’ polysaccharide nanofibers can also be scaled up with low cost;

(5) The fabrication processes of the nanofibrous MF membranes are environmentally friendly since water is the primary solvent involved in the cellulose coating/infusion procedure.

While the above description contains many specific details of methods in accordance with this disclosure, these specific details should not be construed as limitations on the scope of the disclosure, but merely as exemplifications of preferred embodiments thereof. Those skilled in the art will envision many other possible variations that are all within the scope and spirit of the disclosure.

What is claimed is:

1. A membrane comprising
a substrate layer; and
a porous layer comprising a nanofibrous scaffold layer, the porous layer being on at least a portion of the substrate layer,
wherein the substrate layer, the scaffold layer, or both, further comprise ultra-fine nanofibers having a diameter from about 3 nm to about 50 nm and a length from about 100 nm to about 5000 nm.

2. The membrane of claim 1, wherein the substrate layer comprises microfibers having diameters from about 1 μm to about 100 μm.

3. The membrane of claim 1, wherein the scaffold layer comprises nanofibers having diameters from about 50 nm to about 500 nm.

4. The membrane of claim 1, wherein the scaffold layer possesses pores with average pore sizes from about 10 nm to about 200 μm.

5. The membrane of claim 1, wherein the scaffold layer comprises a polymer selected from the group consisting of polyolefins, polysulfones, polyethersulfones, fluoropolymers, polyvinylidene fluorides, polyesters, polyamides, polycarbonates, polystyrenes, polyacrylonitriles, poly(meth)acrylates, polyvinylacetates, polyvinyl alcohols, polysaccharides, cellulose, chitosan, chitin, hyaluronic acid, proteins, polyalkylene oxides, polyurethanes, polyureas, polyvinyl chlorides, polyimines, polyvinylpyrrolidones, polyacrylic acids, polymethacrylic acids, polysiloxanes, poly(ester-co-glycol)polymers, poly(ether-co-amide)polymers, cross-linked forms thereof, derivatives thereof, and copolymers thereof.

6. The membrane of claim 1, wherein the scaffold layer comprises nanofibers selected from the group consisting of polyolefins, polysulfones, polyethersulfones, fluoropolymers, polyvinylidene fluorides, polyesters, polyamides, polycarbonates, polystyrenes, polyacrylonitriles, poly(meth)acrylates, polyvinylacetates, polyvinyl alcohols, polysaccharides, cellulose, chitosan, chitin, hyaluronic acid, proteins, polyalkylene oxides, polyurethanes, polyureas, polyvinyl chlorides, polyimines, polyvinylpyrrolidones, polyacrylic acids, polymethacrylic acids, polysiloxanes, poly(ester-co-glycol)polymers, poly(ether-co-amide)polymers, cross-linked forms thereof, derivatives thereof, and copolymers thereof.

7. The membrane of claim 1, wherein the scaffold layer has a thickness of from about 10 μm to about 300 μm.

8. The membrane of claim 1, wherein the scaffold layer has a thickness of from about 30 μm to about 150 μm.

9. The membrane of claim 1, wherein the ultra-fine nanofibers comprise polysaccharide nanofibers selected from the group consisting of cellulose, chitin, collagen, gelatin, chitosan, and combinations thereof.

10. The membrane of claim 1, wherein the ultra-fine nanofibers comprise cellulose.

11. The membrane of claim 1, wherein the ultra-fine nanofibers comprise cellulose grafted with chelating groups.

12. The membrane of claim 11, wherein the chelating groups are selected from the group consisting of polyethylenimine, diamine, cystine, thiazolidine, and combinations thereof.

13. The membrane of claim 1, wherein the nanofibers have a diameter from about 3 nm to about 50 nm and a length from about 100 nm to about 5000 nm.

14. The membrane of claim 1, wherein the substrate comprises non-woven fibers of a material selected from the group consisting of poly(ethylene terephthalate), polypropylene, glass and cellulose.

15. The membrane of claim 1, wherein the substrate is woven, cast, extruded or combinations thereof.

16. The membrane of claim 1, wherein the scaffold layer, the substrate layer, or both, further comprise positively charged water-soluble components selected from the group consisting of polyethylenimine, polyvinylamine hydrochloride, polyvinyl trimethylammonium chloride/bromide, poly(vinyl tetraethylphosphonium)bromide, poly(1-vinyl-3-methylimidazolium)chloride, poly(4-vinylpyridium), poly(allylamine) chloride/bromide, chitosan, chitin, ethylamine/propylamine/ethylenediamine, tetraalkylammonium salts, and combinations thereof.

17. The membrane of claim 1, wherein the scaffold layer, the substrate layer, or both, further comprise negatively charged components selected from the group consisting of sodium polyacrylate, poly(sodium 4-vinylstyrene sulfonate), nitrocellulose, sodium acetate, sodium benzoate, terephthalic acid, benzene-1,3,5-tricarboxylic acid, 4-methylbenzenesulfonic acid, and combinations thereof.

18. A method comprising:
passing a fluid through a membrane of claim 1; and
recovering the fluid that has passed through the membrane,
wherein the fluid that has passed through the membrane has a log reduction value of bacteria of from about 4 to greater than about 6.

19. A filter comprising:
at least a first membrane comprising a substrate layer in combination with a porous layer comprising a scaffold layer on at least a portion of the substrate layer;
at least a second membrane adjacent the first membrane, the second membrane comprising a substrate layer in combination with a scaffold layer on at least a portion of the substrate layer;
wherein the substrate layer, the scaffold layer, or both, further comprise ultra-fine nanofibers.

20. The filter of claim 19, wherein the scaffold layer of the first membrane is adjacent the scaffold layer of the second membrane.

21. The filter of claim 19, wherein the scaffold layers comprise a polymer selected from the group consisting of polyolefins, polysulfones, polyethersulfones, fluoropolymers, polyvinylidene fluorides, polyesters, polyamides, polycarbonates, polystyrenes, polyacrylonitriles, poly(meth)acrylates, polyvinylacetates, polyvinyl alcohols, polysaccharides, cellulose, chitosan, chitin, hyaluronic acid, proteins, polyalkyleneoxides, polyurethanes, polyureas, polyvinyl chlorides, polyimines, polyvinylpyrrolidones, polyacrylic acids, polymethacrylic acids, polysiloxanes, poly(ester-co-glycol)polymers, poly(ether-co-amide)polymers, cross-linked forms thereof, derivatives thereof, and copolymers thereof.

22. The filter of claim 19, wherein the scaffold layers comprise polyacrylonitrile, polyethersulfone and combinations thereof.

23. The filter of claim 19, wherein the scaffold layers each have a thickness of from about 10 μm to about 300 μm.

24. The filter of claim 19, wherein the scaffold layers each have a thickness of from about 30 μm to about 150 μm.

25. The filter of claim 19, wherein the ultra-fine nanofibers comprise polysaccharide nanofibers selected from the list consisting of cellulose, chitin, collagen, gelatin, chitosan, and combinations thereof.

26. The filter of claim 19, wherein the ultra-fine nanofibers comprise cellulose nanofibers.

27. The filter of claim 26, wherein the cellulose nanofibers have a thickness from about 3 nm to about 50 nm and a length from about 100 nm to about 5000 nm.

28. The filter of claim 19, wherein the scaffold layer, the substrate layer, or both, further comprise a positively charged water-soluble polymer selected from the group consisting of polyethylenimine, chitosan, poly(1-vinyl-3-butylimidazolium) bromine, polyvinylamine hydrochloride, and combinations thereof.

29. A method comprising:
passing a fluid through a filter of claim 19; and
recovering the fluid that has passed through the filter,
wherein the fluid that has passed through the filter has a log reduction value of bacteria of from about 4 to greater than about 6.

30. A method comprising:
passing a fluid through a filter of claim 19; and
recovering the fluid that has passed through the filter,
wherein the fluid that has passed through the filter has a log reduction value of viruses of greater than 4.

31. A method comprising:
passing a fluid through a filter of claim 19; and
recovering the fluid that has passed through the filter,
wherein the filter has the capacity for adsorption of greater than about 68 mg of a dye/gram membrane.

32. A method comprising:
passing a fluid through a filter of claim 19; and
recovering the fluid that has passed through the filter,
wherein the filter has the capacity for adsorption of greater than about 1.5 mg Cr(VI)/gram membrane.

33. A method comprising:
passing a fluid through a filter of claim 19; and
recovering the fluid that has passed through the filter,
wherein the filter has the capacity for adsorption of greater than about 167 mg UO₂²⁺/gram cellulose nanofibers.
